(19) United States
(12) Patent Application Publication
(10) Pub. No.: US 2022/0414908 A1
(43) Pub. Date: Dec. 29, 2022

(54) IMAGE PROCESSING METHOD

(71) Applicant: BEIJING DAJIA INTERNET INFORMATION TECHNOLOGY CO., LTD., Beijing (CN)

(72) Inventor: Tian CHEN, Beijing (CN)

(21) Appl. No.: 17/822,923

(22) Filed: Aug. 29, 2022

Related U.S. Application Data
(63) Continuation of application No. PCT/CN2020/139034, filed on Dec. 24, 2020.

(30) Foreign Application Priority Data
Apr. 27, 2020 (CN) 202010346467.7

(51) Int. Cl. G06T 7/55

(52) U.S. Cl. CPC G06T 7/55; G06T 2207/20221; G06T 2207/20084

(57) ABSTRACT

An image processing method includes: obtaining an initial depth image corresponding to a current frame image according to a convolutional neural network; determining a predicted depth image corresponding to the current frame image according to posture offset information corresponding to the current frame image and a previous frame image of the current frame image, wherein the posture offset information refers to a posture offset of an image collection device between a first position where the previous frame image is collected and a second position where the current frame image is collected; fusing an initial depth value in the initial depth image and a predicted depth value in the predicted depth image of a pixel point having a same position in both images to obtain a target depth value; and generating a depth image corresponding to the current frame image according to the target depth value.

### CROSS-REFERENCE TO RELATED APPLICATION

The present disclosure is a continuation of International Application No. PCT/CN2020/139034, filed Dec. 24, 2020, which claims priority to Chinese Patent Application No. 202010346467.7, filed Apr. 27, 2020, the entire disclosures of which are incorporated herein by reference.

### FIELD

The present disclosure relates to a field of computer technology, and in particular, to an image processing method.

### BACKGROUND

Mixed reality (MR) technology is known as an advanced augmented reality (AR) technology, and introduces physical scene information into a virtual environment and builds an interactive feedback information loop among a virtual world, a physical reality and a user, thus improving a sense of reality of the user.

In MR technology, in order to better control a positional relationship between virtual objects in the virtual world and physical objects in the physical world, an image of each frame of a video collected by an intelligent terminal has to be subjected to depth estimation to obtain a depth image exhibiting a dense depth feature.

### SUMMARY

According to a first aspect of embodiments of the present disclosure, an image processing method is provided, the method including: acquiring a current frame image from a collected video; obtaining an initial depth image corresponding to the current frame image according to a convolutional neural network; determining a predicted depth image corresponding to the current frame image according to posture offset information corresponding to the current frame image and a previous frame image of the current frame image, in which the posture offset information indicates a posture offset of an image collection device between a first position where the previous frame image is collected and a second position where the current frame image is collected; fusing an initial depth value in the initial depth image and a predicted depth value in the predicted depth image of a pixel point at a same position in the initial depth image and the predicted depth image to obtain a target depth value corresponding to the pixel point; and generating a depth image corresponding to the current frame image according to the target depth value corresponding to the pixel point in the current frame image.

According to a second aspect of embodiments of the present disclosure, an electronic device is provided, the electronic device including: a memory for storing executable instructions; a processor for reading and executing the executable instructions stored in the memory to implement the image processing method as described in the first aspect of the present disclosure.

According to a third aspect of embodiments of the present disclosure, a non-transitory computer-readable storage medium is provided. In response to instructions in the storage medium being executed by a processor, the processor executes the image processing method as described in the first aspect of embodiments of the present disclosure.

### BRIEF DESCRIPTION OF THE DRAWINGS

FIG. 1 is a flowchart of an image processing method according to an exemplary embodiment;

FIG. 2 is a schematic diagram showing an application scenario according to an exemplary embodiment;

FIG. 3 is a schematic diagram showing a feature region according to an exemplary embodiment;

FIG. 4 is a schematic diagram showing a preset range corresponding to pixel coordinates of a current frame image according to an exemplary embodiment;

FIG. 5 is a schematic diagram showing a propagating pixel point region and a newly added pixel point region in a current frame image according to an exemplary embodiment;

FIG. 6 is a block diagram showing an image processing apparatus according to an exemplary embodiment;

FIG. 7 is a block diagram showing an electronic device according to an exemplary embodiment.

### DETAILED DESCRIPTION

In order to make those skilled in the art better understand the technical solutions of the present disclosure, the technical solutions in embodiments of the present disclosure will be clearly and completely described below with reference to the accompanying drawings.

Certain terms used in the present specification are explained below to help those skilled in the art understand embodiments of the present disclosure.

(1) The term “a plurality of” the present disclosure refers to two or more than two, and other quantifiers have a similar meaning.

(2) The term “depth image,” which may also referred to as a distance image, refers to an image in which a distance (depth) from an image collection device to each point in a scene is taken as a pixel value, and directly reflects a geometry of a visible surface of an object in the scene.

(3) The term “RGB image” refers to a common color image, where RGB stands for colors of three channels of red, green and blue. A variety of colors can be obtained by changing the three color channels of red (R), green (G) and blue (B) and/or superposing any two or all of the three color channels.

(4) The term “grayscale image” refers to an image in which a pixel value of each pixel point is a grayscale value.

(5) The term “image resolution” refers to an amount of information stored in an image, and refers to the number of pixels per inch in an image. The resolution has a unit of PPI that is pixel per inch. The image resolution is usually expressed in a manner of “the number of pixels in a horizontal direction x the number of pixels in a vertical direction”.

In MR technology, in order to better control the positional relationship between virtual objects in the virtual world and physical objects in the physical world, an image of each frame of a video collected by an intelligent terminal has to be subjected to depth estimation obtain a depth image exhibiting a dense depth feature. The depth image, also known as a distance image, refers to an image in which a distance (depth) from an image collection device to each point in a scene is taken as a pixel value, directly reflects a geometry of a visible surface of an object in the scene, and further determines a position of the image collection device itself in the environment as well as establishes a model of a surrounding environment.

With the popularization of smart terminals, users have a higher requirement for the smart terminals. The smart terminals realize AR technology, MR technology, and the like based on depth images. One depth image may be generated by a depth image collection device or a binocular image collection device. In this way, the smart terminal needs to be added with a hardware such as an RGB-D sensor or camera, which increases cost and power consumption. With development of machine learning, the depth image can be determined through training and learning without the need for sophisticated hardware, and a convolutional neural network is widely used in the field of image processing.

According to embodiments of the present disclosure, an image processing method is provided, which improves a stability of the depth images corresponding to adjacent two frame images output by the convolutional neural network.

In order to make purposes, technical solutions and advantages of the present disclosure clearer, the present disclosure will be further described in detail below with reference to the accompanying drawings. It should be noted that the described embodiments are only a part of the embodiments of the present disclosure, rather than all of them. Based on the embodiments in the present disclosure, all other embodiments obtained by those skilled in the art without any creative work fall within the scope of the present disclosure.

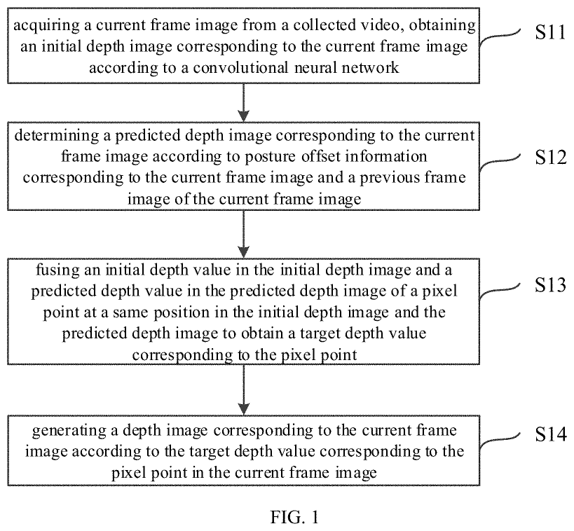

FIG. 1 is a flowchart of an image processing method according to an exemplary embodiment. Referring to FIG. 1, the method includes the following steps.

In S11, a current frame image is acquired from a collected video; an initial depth image corresponding to the current frame image is obtained according to a convolutional neural network.

In S12, a predicted depth image corresponding to the current frame image is determined according to posture offset information corresponding to the current frame image and a previous frame image of the current frame image. The posture offset information indicates a posture offset of an image collection device between a first position where the previous frame image is collected and a second position where the current frame image is collected.

In S13, an initial depth value in the initial depth image and a predicted depth value in the predicted depth image of a pixel point at a same position in the initial depth image and the predicted depth image are fused to obtain a target depth value corresponding to the pixel point;

In S14, a depth image corresponding to the current frame image is generated according to the target depth value corresponding to the pixel point in the current frame image.

As can be seen from the above, in the image processing method disclosed in embodiments of the present disclosure, the initial depth image corresponding to the current frame image is obtained, the predicted depth image corresponding to the current frame image is determined according to the posture offset information corresponding to the current frame image and the previous frame image of the current frame image, the initial depth value in the initial depth image and the predicted depth value in the predicted depth image of the pixel point at the same position are fused to obtain the target depth value corresponding to the pixel point, and the depth image corresponding to the current frame image is generated according to the target depth value corresponding to the pixel point in the current frame image. The image processing method provided by embodiments of the present disclosure can calibrate the initial depth image of the current frame image output by the convolutional neural network based on the predicted depth image corresponding to the current frame image. Since the predicted depth image corresponding to the current frame image can be determined according to the previous frame image and the position offset information, the correlation of the adjacent two frame images can be considered in a case where the target depth value is determined according to the initial depth value and the predicted depth value. The depth value of the pixel point in the depth image generated according to the target depth value may be more stable, thereby reducing fluctuation between the depth values of the corresponding point in the two adjacent frame images. The depth image of the current frame image output by the convolutional neural network is calibrated with the previous frame image, and the depth image with a high inter-frame stability can be obtained.

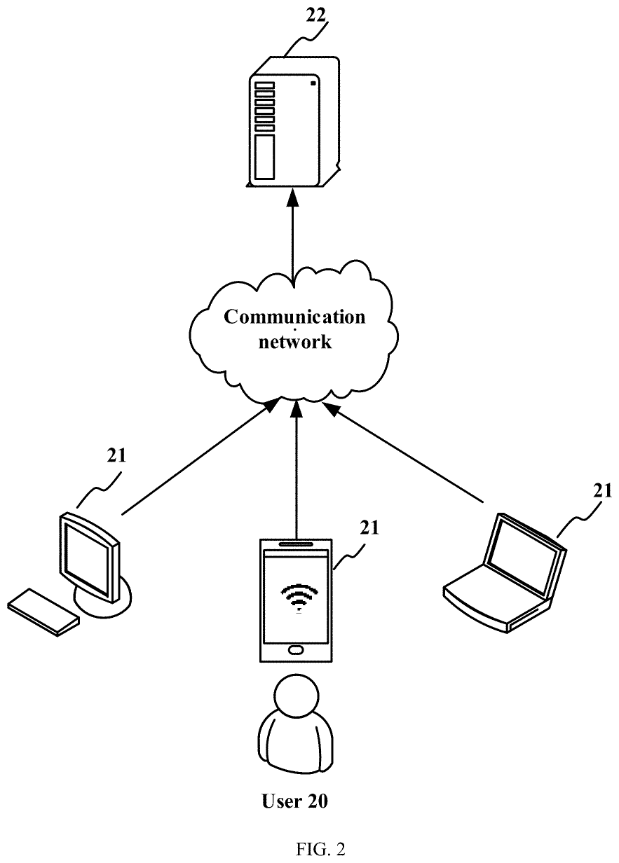

In some embodiments, an application scenario may be shown as the schematic diagram of FIG. 2. An image collection device is installed in a terminal device 21. A user 20 collects a video by the image collection device of the terminal device 21. In some embodiments, the image collection device sends a current frame image in the collected video and posture offset information corresponding to the current frame image to a server 22. The server 22 inputs the current frame image into a trained convolutional neural network to obtain an initial depth image corresponding to the current frame image, determines a predicted depth image corresponding to the current frame image according to the posture information corresponding to the current frame image and a previous frame image of the current frame image, fuses an initial depth value in the initial depth image and a predicted depth value in the predicted depth image of a pixel point that is located at a same position in the two images to obtain a target depth value corresponding to the pixel point, and generates a depth image corresponding to the current frame image according to the target depth value corresponding to each pixel point. The server 22 sends the depth image corresponding to the current frame image to the image collection device in the terminal device 21, and the image collection device renders an original RGB image corresponding to the current frame image according to the depth image corresponding to the current frame image and then displays it to the user 20.

It should be noted that, in the above-mentioned application scenario, the previous frame image of the current frame image may have been stored in the server 22, or may be sent by the image collection device to server 22 together with the posture offset information corresponding to the current frame image. The above-mentioned scenario is merely exemplary, and should not be construed to limit the scope of the present disclosure.

In the image processing method disclosed in an embodiment of the present disclosure, the initial depth image corresponding to the current frame image needs to be determined firstly. Since AR technology and MR technology usually process a video collected in real time, an image to be processed is the current frame image of the collected video.

In some embodiments, the current frame image is input into a trained convolutional neural network to obtain the initial depth image corresponding to the current frame image which is output by the trained convolutional neural network.

In some embodiments, the convolutional neural network is trained by a large number of RGB images and a depth value corresponding to each pixel point in the RGB image. A matrix formed by the RGB image and the depth value corresponding to each pixel point in the RGB image is used as an input of the convolutional neural network, and a depth image corresponding to the RGB image is used as an output of the convolutional neural network. The convolutional neural network is trained, and it is determined that the training of the convolutional neural network is completed once a convergence of the convolutional neural network model is acquired. The trained convolutional neural network is capable of determining a depth image according to an RGB image.

In some embodiments, the current frame image is input into the trained convolutional neural network, and the trained convolutional neural network calculates the initial depth value of every pixel point of the current frame image according to a pixel feature of the current frame image. The depth value of every pixel point is taken as a pixel value of the initial depth image to generate the initial depth image corresponding to the current frame image.

In some embodiments of the present disclosure, a correlation between the previous frame image and the current frame image is considered, according to the previous frame image and the posture offset information of the image collection device between a first position where the previous frame image is collected and a second position where the current frame image is collected. The current frame image is subjected to a depth estimation according to the depth image corresponding the previous frame image, and the predicted depth image corresponding to the current frame image is generated. Further, by fusing the initial depth image and the predicted depth image corresponding to the current frame image, a fluctuation of the depth value of the corresponding point of the current frame image relative to the previous frame image is reduced.

In some embodiments of the present disclosure, the posture offset information includes a rotation matrix and a translation vector. In the embodiments of the present disclosure, the rotation matrix of the image collection device between the first position where the previous frame image is collected and the second position where the current frame image is collected is obtained in the following way.

The rotation matrix of the image collection device between the first position where the previous frame image is collected and the second position where the current frame image is collected is determined according to a first inertial measurement unit (IMU) parameter value of the image collection device when collecting the previous frame image, and a second IMU parameter value of the image collection device when collecting the current frame image.

In some embodiments, the IMU is a device for measuring a three-axis attitude angle and acceleration of the image collection device. It can measure an angular velocity and acceleration of an object in the three-dimensional space, and thereby determining the posture of the image collection device. There is an IMU record every time the image collection device collects a frame of image, which represents an angle of the image collection device with respect to each of the three coordinate axes in a world coordinate system when the image collection device collects each frame image. The first IMU parameter value is determined by reading the IMU record of the image collection device when collecting the previous frame image, and the second IMU parameter value is determined by reading the IMU record of the image collection device when collecting the current frame image. A change in the angle of the image collection device with respect to the three coordinate axes in the world coordinate system (i.e., a rotation situation of the image collection device in the three dimensionalities) is determined according to the first IMU parameter value and the second IMU parameter value and is represented by a matrix, thus determining the rotation matrix of the image collection device. In an embodiment, the rotation matrix is a third-order square matrix, represented by R.

In some embodiments of the present disclosure, at least one feature region is determined from the previous frame image based on a GFTT feature extraction algorithm. For each feature region, according to a first position information of the feature region in the previous frame image and an optical flow tracking algorithm, a second position information of the feature region in the current frame image is determined. The second position information in the current frame image. Based on a PNP algorithm, the first position information of at least one feature region in the previous frame image and the second position information of at least one feature region in the current frame image are optimized to obtain the translation vector of the image collection device between a first position where the device collects the previous frame image and a second position where the image collection device collects the current frame image.

A difference between a gray value of an edge pixel point of the feature region and a gray value of an adjacent pixel point of a region except the feature region is greater than a preset threshold.

In some embodiments, the difference between the gray value of the edge pixel point of the feature region and the gray value of the adjacent pixel point is relatively large. The first position information of the at least one feature region in the previous frame image is determined by the GFTT feature point extraction technology. For each feature region, the first position information of the feature region in the previous frame image is determined, the second position information of the feature region in the current frame image is determined by the optical flow tracking algorithm. The first position information and the second position information of all feature regions are optimized according to the PNP algorithm, thereby obtaining the translation vector of the image collection device.

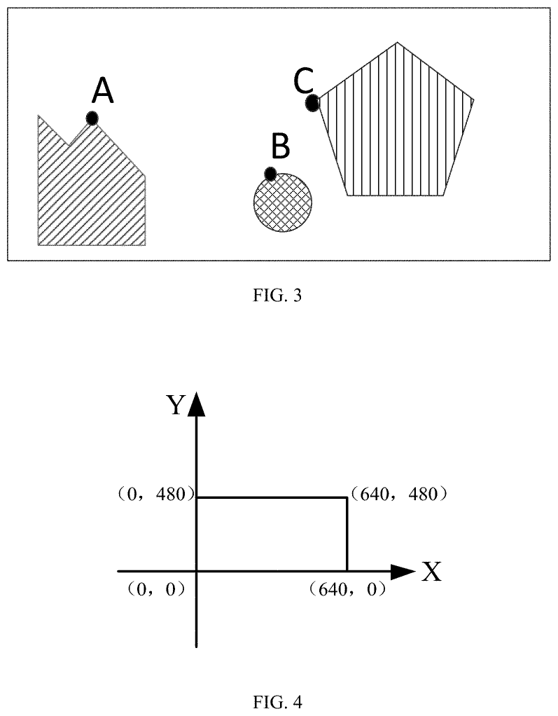

In some embodiments, at least one feature point can be extracted from the previous frame image by the GFTT feature point extraction technology. As shown in FIG. 3, three feature regions A, B, and C are determined. The first position information of at least one feature region in the previous frame image is determined, and optical flow tracking is performed on the feature region to determine the second position information of at least one feature region in the current frame image. Comprehensively considering depth values of the feature region in the depth image corresponding to the previous frame image and in the initial depth image corresponding to the current frame image, the first position information and the second position information, a position is determined, i.e., left and right position information, up and down position information, and front and rear position information of the image collection device in the world coordinate when the image collection device collects the image. The first position information and the second position information of the feature region are optimized by using the PNP algorithm, translation information of the image collection device from the first position where the image collection device collects the previous frame image to the second position where it collects the current frame image is determined and is represented by a matrix, thus determining the translation vector corresponding the image collection device. In an embodiment, the translation vector is a vector with three rows and one column, and is represented by T.

After the posture offset information of the current frame image is determined, the predicted depth image corresponding to the current frame image is determined according to the previous frame image and the posture offset information of the current frame image.

In some embodiments, for any pixel point of the previous frame image, a pixel coordinate of this pixel point in the previous frame image is converted into a first spatial coordinate according to an internal parameter of the image collection device; the first spatial coordinate is converted into a second spatial coordinate according to the posture offset information; a pixel point is determined as a propagating pixel point in the current frame image in response to the pixel coordinate converted from the second spatial coordinate being within a preset range, and a predicted depth value of the propagating pixel point is determined according to the second spatial coordinate; a preset depth value is determined as a predicted depth value of a pixel point except the propagating pixel point (i.e., a newly added pixel point) in the current frame image; the predicted depth image corresponding to the current frame image is determined according to the predicted depth value of the propagating pixel point and the predicted depth value of the newly added pixel point.

In some embodiments, according to the internal parameter of the image collection device and the posture offset information, a pixel coordinate of any pixel point in the previous frame image is converted into a pixel coordinate of the pixel point obtained after the posture offset of the image collection device. In response to the pixel coordinate being within a preset range, the pixel point can be determined as the propagating pixel point of the current frame image, indicating a physical object point corresponding to the pixel point is within an imaging range of the image collection device collecting the previous frame image, and it is also within an imaging range of the image collection device collecting the current frame image. In response to the pixel coordinate not being within the preset range, it can be indicated that the object point corresponding to this pixel point is moved out of the imaging range of the image collection device during the posture offset of the image collection device. In the current frame image, the pixel points, except the propagating pixel points, are all newly added pixel points. The predicted depth value of the propagating pixel point is determined according to the second spatial coordinate, the preset depth value being determined as the predicted depth value of the newly added pixel point, and the predicted depth image corresponding to the current frame image is generated.

The preset range is a range of a pixel coordinate of the current frame image, which is determined by a resolution of the image. The resolution of the image can be represented by the number of pixel points in the horizontal and vertical directions of the image. For example, the resolution of the image is 640*480, the preset range is a rectangle formed by coordinates (0, 0), (640, 0), (0, 480) and (640, 480), as shown in FIG. 4.

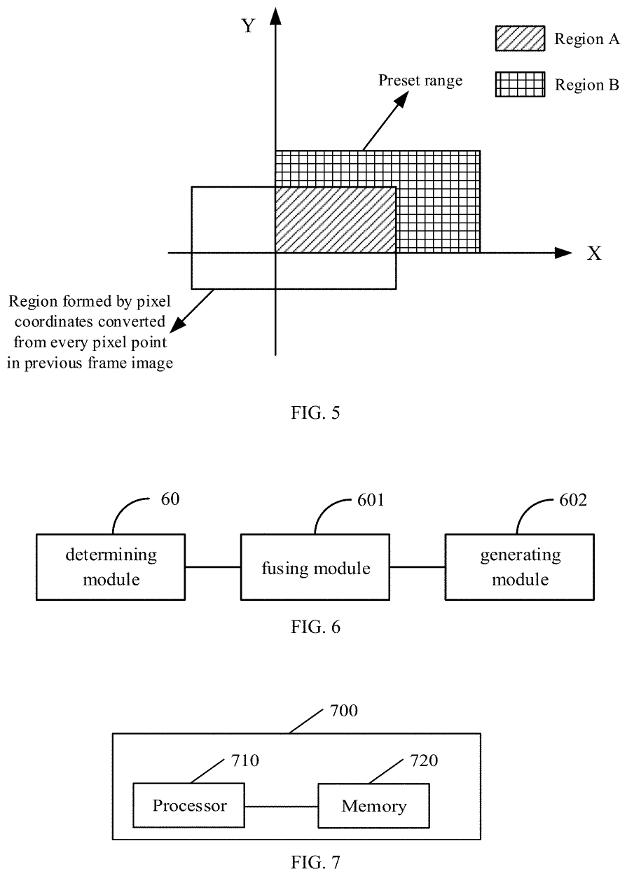

During the determination of the propagating pixel point and the newly added pixel point, for any pixel point in the previous frame image, the first spatial coordinate corresponding to the pixel coordinate of the pixel point in the previous frame image is determined. The second spatial coordinate converted from the first spatial coordinate is determined according to the first spatial coordinate and the posture offset information, and the pixel coordinate converted from the second spatial coordinate is determined. A region is formed by the converted pixel coordinates of all pixel points in the previous frame image, and the region overlaps with a region formed by the preset range—that is, a region formed by the propagating pixel points in the current frame image. In the current frame image, a region formed by pixel points except the propagating pixel points is a region formed by the newly added pixel points in the current frame image. As shown in FIG. 5, which is a schematic diagram of a propagating pixel point region and a newly added pixel point region in a current frame image according to an embodiment of the present disclosure, the region formed by the converted pixel coordinates of all the pixel points in the previous frame image and the preset range are shown in FIG. 5. In FIG. 5, the propagating pixel point region in the current frame image is represented by a region A, and the newly added pixel point region in the current frame image is represented by a region B.

In some embodiments, the pixel coordinate of any pixel point in the previous frame image is converted into the first spatial coordinate according to the internal parameter of the image collection device; and the first spatial coordinate is converted into the second spatial coordinate according to the posture offset information.

In some embodiments, the internal parameter of the image collection device includes a focal length, a main point, a tilt coefficient, a distortion coefficient, etc., and an internal parameter matrix K of the image collection device is determined by the internal parameter, and the internal parameter matrix K is a third-order square matrix, for example, the internal parameter matrix K is shown in formula (1):

$$K = [ \begin{matrix}{f}_{x} & s & {c}_{x} \\ 0 & {f}_{y} & {c}_{y} \\ 0 & 0 & 1\end{matrix} ] \qquad formula ( 1 )$$

where, fₓ and f_{y} are a focal length, respectively, and are equal to each other in general, cₓ and c_{y} are a main point coordinate relative to the imaging plane, respectively, and s is a tilt parameter of a coordinate axis, and is 0 ideally.

The pixel coordinate of the pixel point in the previous frame image is converted into the first spatial coordinate according to a conversion formula as shown in formula (2):

$$[ \begin{matrix}X \\ Y \\ Z\end{matrix} ] = {[ \begin{matrix}{f}_{x} & s & {c}_{x} \\ 0 & {f}_{y} & {c}_{y} \\ 0 & 0 & 1\end{matrix} ]}^{- 1} [ \begin{matrix}u \\ v \\ 1\end{matrix} ] \qquad formula ( 2 )$$

where (u, v) represents a position of a pixel point in the previous frame image, (X, Y, Z) represents a first spatial coordinate corresponding to the pixel point, and represents a position of an object point corresponding to the pixel point in the spatial coordinate system, a value of Z is equal to a depth value of the pixel point in the depth image corresponding to the previous frame image.

After the first spatial coordinate of the pixel point is obtained, the first spatial coordinate is converted into the second spatial coordinate according to the posture offset information represented by a conversion formula as shown in formula (3):

$$[ \begin{matrix}{X}^{′} \\ {Y}^{′} \\ {Z}^{′} \\ 1\end{matrix} ] = [ \begin{matrix}R & T \\ 0 & 1\end{matrix} ] [ \begin{matrix}X \\ Y \\ Z \\ 1\end{matrix} ] \qquad formula ( 3 )$$

where R is a rotation matrix, T is a translation matrix, and (X′Y′Z′) is a second spatial coordinate of the pixel point, and represents a position of the object point corresponding to the pixel point in the spatial coordinate system after a posture change of the image collection device.

In the determination of the predicted depth value of the propagating pixel point according to the second spatial coordinate, a value of Z′ is the predicted depth value of the propagating pixel point.

The second spatial coordinate of the pixel point is converted into a pixel coordinate according to the internal parameter of the image collection device according to a conversion formula as shown in formula (4):

$$[ \begin{matrix}{u}^{′} \\ {v}^{′} \\ 1\end{matrix} ] = [ \begin{matrix}{f}_{x} & s & {c}_{x} \\ 0 & {f}_{y} & {c}_{y} \\ 0 & 0 & 1\end{matrix} ] [ \begin{matrix}{X}^{′} \\ {Y}^{′} \\ {Z}^{′}\end{matrix} ] \qquad formula ( 4 )$$

where (u′, v′) represents a pixel coordinate converted from the second spatial coordinate of the pixel point, and (u′, v′) also represents a position of the propagating pixel point in the current frame.

In some embodiments, in response to the predicted depth image being generated the position of the propagating pixel point in the current frame image is determined according to the pixel coordinate converted from the second spatial coordinate. Another position in the current frame image, except the position of the propagating pixel point, is determined as a position of the newly added pixel point in the current frame image. The predicted depth image corresponding to the current frame image is generated according to: the position of the propagating pixel point in the current frame image, the predicted depth value of the propagating pixel point, the position of the newly added pixel point in the current image, and the predicted depth value of the newly added pixel point.

In some embodiments, a position (u′, v′) of any propagating pixel point in the current frame image can be determined according to formula (4); and any other position except the position of the propagating pixel point is determined as the position of the newly added pixel point. That is, as shown in FIG. 5, a position in region A is the position of the propagating pixel point region in the current frame image, and a position in region B is the position of the newly added pixel point region in the current frame image.

The predicted depth value Z′ of the propagating pixel point can be determined according to formula (3). A preset depth value can be provided as a predicted depth value of any newly added pixel point in the current frame image. In an implementation, the preset depth value can be 0. The reason for presetting a depth value as the predicted depth value of the newly added pixel point will be described in detail in the following embodiments.

The position of the propagating pixel point in the current frame image is determined, and the predicted depth value of the propagating pixel point is determined as a pixel value at the position of the propagating pixel point. The position of the newly added pixel point in the current frame image is determined, and the predicted depth value of the newly added pixel point is determined as a pixel value at the position of the newly added pixel point. In this way, the predicted depth image corresponding to the current frame image is generated.

Since the predicted depth image corresponding to the current frame image is determined based on the previous frame image subjected to the same posture offset as the one that the image collection device has been subjected to, theoretically the predicted depth value corresponding to the pixel point at the same position should be equal to its initial depth value. However, the initial depth value of the pixel point in the initial depth image output by the convolutional neural network does not consider a correlation between the adjacent two frame images, the predicted depth value may not be equal to the initial depth value. According to embodiments of the present disclosure, the target depth value considering the correlation between the adjacent two frame images is obtained by fusing the initial depth value of the pixel point in the initial depth image and the predicted depth value of the pixel point in the predicted depth image (the pixel point has the same position in the two images). The depth value of the pixel point of the depth image generated by the target depth value is more stable than that of the initial depth image pixel output by the convolutional neural network.

In some embodiments, the target depth value corresponding to the pixel point is determined according to: the initial depth value of the pixel point at the same position, the predicted depth value of the pixel point, a first weight value corresponding to the initial depth value, and a second weight value corresponding to the predicted depth value.

In some embodiments, a first weight is assigned to the initial depth value, a second weight is assigned to the predicted depth value, and the initial depth value and the predicted depth value are fused according to the weights to obtain the target depth value.

In some embodiments, the fusion of the initial depth value and the predicted depth value may be performed by performing a weighted average operation on the initial depth value and the predicted depth value according to the first weight corresponding to the initial depth value and the second weight corresponding to the predicted depth value to obtain the target depth value. For example, the initial depth value and the predicted depth value are fused according to formula (5):

$$D = \frac{{U}_{1} {D}_{1} + {U}_{2} {D}_{2}}{{U}_{1} + {U}_{2}} \qquad formula ( 5 )$$

where D₁ is the initial depth value of the pixel point in the predicted depth image corresponding to the current frame image; D₂ is the predicted depth value of the pixel point in the predicted depth image corresponding to the current frame image; U₁ is the first weight corresponding to the initial depth value of the pixel point; U₂ is the second weight corresponding to the predicted depth value of the pixel point.

It should be noted that the “fusing” in the embodiment of the present disclosure does not only include the “weighted average operation”. Other operation methods known by those skilled in the art to fuse the initial depth value and the predicted depth value are all included in the scope of embodiments of the present disclosure.

Before determining the target depth value, the first weight corresponding to the initial depth value of the pixel point and the second weight corresponding to the predicted depth value of the pixel point need to be determined.

In some embodiments, the first weight corresponding to the initial depth value is determined according to the following: an initial propagation uncertainty parameter corresponding to the pixel point is determined according to a difference between the initial depth value and the predicted depth value; a regulatory factor for adjusting the initial propagation uncertainty parameter is determined according to the difference between the initial depth value and the predicted depth value; the initial propagation uncertainty parameter is adjusted according to the regulatory factor and a ratio of the initial depth value to the predicted depth value, and the first weight value corresponding to the initial depth value is determined.

In some embodiments, the initial propagation uncertainty parameter corresponding to the pixel point is determined according to the difference between the initial depth value and the predicted depth value, and a determination formula for determining the initial propagation uncertainty parameter corresponding to the pixel point is as shown in formula (6):

d′=|D₁−D₂|

u=d′² formula (6)

where d′ is the difference between the initial depth value and the predicted depth value; D₁ is the initial depth value; D₂ is the predicted depth value; u is the initial propagation uncertainty parameter.

The regulatory factor for adjusting the initial propagation uncertainty parameter is determined according to the difference between the initial depth value and the predicted depth value, a determination formula for determining the regulatory factor is as shown in formula (7):

$$σ = 0.5 + \frac{21}{1 + {20}^{3 - {d}^{′} * 35}} \qquad formula ( 7 )$$

where σ is the regulatory factor; d′ is the difference between the initial depth value and the predicted depth value; other parameters in the formula are obtained by fitting a large number of samples in experiments meanwhile or after selecting a quadratic curve. The other parameters can be adjusted in practice and are not limited in the embodiments of the present disclosure. The quadratic curve has a general formula as shown in formula (8):

$$σ = a + \frac{b}{c + {d}^{e - {d}^{′} * f}} \qquad formula ( 8 )$$

It can be seen that as the difference between the initial depth value and the predicted depth value increases, the initial propagation uncertainty parameter increases and the regulation factor increases.

The initial propagation uncertainty parameter is adjusted according to the regulatory factor and the ratio of the initial depth value to the predicted depth value, and the first weight value corresponding to the initial depth value is determined. A formula for adjusting the initial propagation uncertainty parameter to determine the first weight value is as shown in formula (9):

$${U}_{1} = \frac{{D}_{2}}{{D}_{1}} u σ + {σ}_{p}^{2} \qquad formula ( 9 )$$

where u is the initial propagation uncertainty parameter; D₁ is the initial depth value; D₂ is the predicted depth value; σ is the regulatory factor; σₚ² is a noise parameter, which is a preset value.

It can be seen that in a case where the adjusted initial propagation uncertainty parameter is determined as the first weight corresponding to the initial depth value, as the initial propagation uncertainty parameter increases, the regulation factor increases and the adjusted initial propagation uncertainty parameter increases, i.e., the first weight increases. During fusion of the initial depth value and the predicted depth value, the larger the first weight corresponding to the initial depth value is, the closer the determined target depth value is to the initial depth value. In other words, in a case where the difference between the initial depth value and the predicted depth value of the pixel point is relatively large, it can be determined that the object point corresponding to the pixel point is a point of a dynamic object or a boundary point in the environment where the image collection device is located. For the point of the dynamic object or the boundary point, the fusion requirement should be lowered to make the target depth value close to the initial depth value. In response to the target depth value being close to the predicted depth value determined from the previous frame image, a delay phenomenon of the dynamic object may be caused.

Embodiments of the present disclosure can improve the effect of determining the target depth value of the point of the dynamic object.

In some embodiments, the second weight value corresponding to the initial depth value is determined in the following way.

In response to the pixel point being the propagating pixel point, the second weight value corresponding to the predicted depth value of the propagating pixel point is determined to be the propagation uncertainty parameter of the pixel point in the previous frame image corresponding to the propagating pixel point; or in response to the pixel point being the newly added pixel point, the second weight value corresponding to the predicted depth value of the newly added pixel point is determined to be the first preset value.

The propagation uncertainty parameter represents a degree of change between a depth value of the propagating pixel point and a depth value of the corresponding pixel point in the previous frame image.

In some embodiments, the methods for determining the second weight corresponding to the predicted depth value are different for the propagating pixel point and the newly added pixel point. Two methods for determining the second weight are described below respectively.

1. For a propagating pixel point, a propagation uncertainty parameter of a pixel point in a previous frame image is determined as a predicted depth value of the propagating pixel point.

The propagation uncertainty parameter represents a degree of change between a depth value of the propagating pixel point and a depth value of the corresponding pixel point in the previous frame image during the posture change of the image collection device. In some embodiments, after the depth image corresponding to each frame of image is determined, the propagation uncertainty parameter of the pixel point in each frame of image is also determined.

For the propagating pixel point in the current frame image, a second weight is determined by the propagation uncertainty parameter of the corresponding pixel point in the previous frame image.

In response to the corresponding pixel point in the previous frame image being a propagating pixel point, a propagation uncertainty parameter of the pixel point in the previous frame image is determined according to a first weight corresponding to an initial depth value and a second weight corresponding to a predicted depth value of the pixel point in the previous frame image, and this propagation uncertainty parameter from the previous frame image is determined as the second weight corresponding to the predicted depth value of the pixel point in the current frame image.

In response to the corresponding pixel point in the previous frame image being a newly added pixel point, a propagation uncertainty parameter of the pixel point in the previous frame image is determined, for example, as a preset value of −1. In a case where it is determined that the propagation uncertainty parameter of the corresponding pixel point (i.e., corresponding to the propagating pixel point in the current frame image) in the previous frame image is −1, the first weight of the propagating pixel point in the current frame image is used as the second weight corresponding to the pixel point. According to formula (5), in a case where the second weight is set to be equal to the first weight, this formula is equivalent to an average operation of the predicted depth value and the initial depth value of the propagating pixel point, that is an average value of the predicted depth value and the initial depth value is used as a target depth value.

2. For a newly added pixel point, a second weight value corresponding to a predicted depth value of the newly added pixel point is determined as a first preset value.

In some embodiments, the second weight corresponding to the predicted depth value of the newly added pixel point is a preset value, for example, the preset value may be any value.

Herein, the reason for setting the predicted depth value of the newly added pixel point to be 0 will be explained in detail. Since the newly added pixel point is a newly added point other than pixel points in a previous frame image during the posture change of the image collection device, it cannot be predicted according to the correlation between the previous frame image and the current frame image. Therefore, a target depth value of the newly added pixel point should be equal to an initial depth value. In a case where the predicted depth value of the newly added pixel point is set to 0, the second weight corresponding to the predicted depth value of the newly added pixel point may be any value, but still the target depth value is equal to the initial depth value according to formula (5).

After determining the initial depth value, the first weight corresponding to the initial depth value, the predicted depth value and the second weight corresponding to the predicted depth value of the pixel point of the current frame image, the predicted depth value and the initial depth value are fused to obtain the target depth value, and the depth image corresponding to the current frame image is generated according to the target depth value.

Additionally, in embodiments of the present disclosure, after the depth image corresponding to the current frame image is generated, a propagation uncertainty image corresponding to the current frame image is generated, and a pixel value of the propagation uncertainty image is the propagation uncertainty parameter of the pixel point in the current frame image.

In some embodiments, a ratio of a product of the first weight corresponding to the initial depth value of the propagating pixel point and the second weight corresponding to the predicted depth value of the propagating pixel point to a sum of the first weight corresponding to the initial depth value of the propagating pixel point and the second weight corresponding to the predicted depth value of the propagating pixel point is determined as the propagation uncertainty parameter of the propagating pixel point.

In some embodiments, the propagation uncertainty parameter corresponding to the propagating pixel point in the current frame image is determined according to the first weight corresponding to the initial depth value of the propagating pixel point and the second weight corresponding to the predicted depth value of the propagating pixel point. In an embodiment, the propagation uncertainty parameter corresponding to the propagating pixel point is determined according to formula (10):

$$C = \frac{{U}_{1} * {U}_{2}}{{U}_{1} + {U}_{2}} \qquad formula ( 10 )$$

where C represents the propagation uncertainty parameter of the propagating pixel point; U₁ is the first weight corresponding to the initial depth value of the pixel point; U₂ is the second weight corresponding to the predicted depth value of the pixel point.

It should be noted that, for the newly added pixel point in the current frame image, the propagation uncertainty parameter of the newly added pixel point is determined as a second preset value. For example, the second preset value is −1.

In some embodiments, the propagation uncertainty parameter of the corresponding pixel point (i.e., this pixel point corresponding to the propagating pixel point in the current frame image) in a previous frame image being −1 indicates that the corresponding pixel point in the previous frame image, which corresponds to the propagating pixel point in the current frame image, is a newly added pixel point for the previous frame image. In a case where the propagation uncertainty parameter of this point in the current frame image is to be determined, the second weight U₂ corresponding to the predicted depth value is set to be equal to the first weight U₁ corresponding to the initial depth value, and it can be known according to formula (10) that the propagation uncertainty parameter C of this point is a half of U₁.

A propagation uncertainty parameter of a pixel point in an image corresponding to a static object is close to 0 during the posture change of the image collection device.

In addition, in response to the current frame image being a first frame of a video collected by the image collection device (since there is no previous frame image), the predicted depth image corresponding to the current frame image cannot be determined according to the posture offset information corresponding to the current frame image and the previous frame image.

In an embodiment of the present disclosure, a method for generating a depth image corresponding to the first frame image of the video is provided. In response to the current frame image being the first frame of the video collected by the image collection device, the depth image corresponding to the current frame image can be generated by: the current frame image being input into a trained convolutional neural network to obtain the depth image corresponding to the current frame image output by the trained convolutional neural network.

It should be noted that before applying the convolutional neural network, the convolutional neural network needs to be trained based on a large number of RGB images and a depth value corresponding to each pixel point in the RGB image. A matrix formed by the RGB image and the depth value corresponding to each pixel point in the RGB image is used as an input of the convolutional neural network and a depth image corresponding to the RGB image is used as an output of the convolutional neural network. The convolutional neural network is trained, and it is determined that the training of the convolutional neural network is completed once a convergence of the convolutional neural network model is acquired. The trained convolutional neural network is capable of determining a depth image according to an RGB image.

In some embodiments, the first frame image of the video is input into the trained convolutional neural network, and the trained convolutional neural network will calculate a depth value of each pixel point on the first frame image according to a pixel feature of the first frame image. The depth value of each pixel point is used as a pixel value of the depth image corresponding to the first frame image, the depth image corresponding to the first frame image is generated.

An image processing apparatus is also provided in the embodiments of the present disclosure. Since the image processing apparatus is an apparatus corresponding to the image processing method of the embodiments of the present disclosure and the apparatus has a similar problem-solving principle with the present method, implementations of the apparatus can refer to the implementations of the method, which will not be elaborated herein.

FIG. 6 is a block diagram showing an image processing apparatus according to an exemplary embodiment. Referring to FIG. 6, the apparatus includes a determining module 600, a fusing module 601, and a generating module 602.

The determining module 600 is configured to acquire a current frame image from a collected video; obtain an initial depth image corresponding to the current frame image based on a convolutional neural network; and determine a predicted depth image corresponding to the current frame image according to posture offset information corresponding to the current frame image and a previous frame image of the current frame image, in which the posture offset information indicates a posture offset of an image collection device between a first position where the previous frame image is collected and a second position where the current frame image is collected.

The fusing module 601 is configured to fuse an initial depth value in the initial depth image and a predicted depth value in the predicted depth image of a pixel point at a same position in the initial depth image and the predicted depth image to obtain a target depth value corresponding to the pixel point.

The generating module 602 is configured to generate a depth image corresponding to the current frame image according to the target depth value corresponding to the pixel point in the current frame image.

In an embodiment, the determining module 600 is specifically configured to: convert a pixel coordinate of any pixel point in the previous frame image into a first spatial coordinate according to an internal parameter of the image collection device; convert the first spatial coordinate into a second spatial coordinate according to the posture offset information; determine the pixel point as a propagating pixel point in the current frame image in response to a pixel coordinate converted from the second spatial coordinate being within a preset range, and determining a predicted depth value of the propagating pixel point according to the second spatial coordinate; determine a predicted depth value of a newly added pixel point except the propagating pixel point in the current frame image as a preset depth value; determine the predicted depth image corresponding to the current frame image according to the predicted depth value of the propagating pixel point and the predicted depth value of the newly added pixel point.

In an embodiment, the determining module 600 is specifically configured to: determine a position of the propagating pixel point in the current frame image according to the pixel coordinate converted from the second spatial coordinate, and taking another position in the current frame image except the position of the propagating pixel point as a position of the newly added pixel point in the current frame image; generate the predicted depth image corresponding to the current frame image according to the position of the propagating pixel point in the current frame image, the predicted depth value of the propagating pixel point, the position of the newly added pixel point in the current image, and the predicted depth value of the newly added pixel point.

In an embodiment, the fusing module 601 is further configured to: determine the target depth value corresponding to the pixel point according to the initial depth value and the predicted depth value of the pixel point at the same position, a first weight value corresponding to the initial depth value, and a second weight value corresponding to the predicted depth value.

In an embodiment, the fusing module 601 is further configured to: determine an initial propagation uncertainty parameter corresponding to the pixel point according to a difference between the initial depth value and the predicted depth value, and determining a regulatory factor for adjusting the initial propagation uncertainty parameter according to the difference between the initial depth value and the predicted depth value; and adjust the initial propagation uncertainty parameter according to the regulatory factor and a ratio of the initial depth value to the predicted depth value, and determining the first weight value corresponding to the initial depth value.

In an embodiment, the fusing module 601 is further configured to: in response to the pixel point being the propagating pixel point, determine a second weight value corresponding to the predicted depth value of the propagating pixel point as a propagation uncertainty parameter of the pixel point in the previous frame image corresponding to the propagating pixel point, in which the propagation uncertainty parameter represents a degree of change between a depth value of a propagating pixel point and a depth value of a corresponding pixel point in a previous frame image; or in response to the pixel point being the newly added pixel point, determine a second weight value corresponding to the predicted depth value of the newly added pixel point as a first preset value.

In an embodiment, the fusing module 601 is further configured to: determine the propagation uncertainty parameter of the propagating pixel point in each frame image according to the first weight value corresponding to the initial depth value of the propagating pixel point and the second weight value corresponding to the predicted depth value of the propagating pixel point; or determine the propagation uncertainty parameter of the newly added pixel point in each frame image as a second preset value.

In an embodiment, the fusing module 601 is specifically configured to: determine the propagation uncertainty parameter of the propagating pixel point as a ratio of a product of the first weight value corresponding to the initial depth value of the propagating pixel point and the second weight value corresponding to the predicted depth value of the propagating pixel point to a sum of the first weight value corresponding to the initial depth value of the propagating pixel point and the second weight value corresponding to the predicted depth value of the propagating pixel point.

In an embodiment, the posture offset information includes a rotation matrix. The determining module 600 is specifically configured to determine the posture offset information of the image collection device between the first position where the previous frame image is collected and the second position where the current frame image is collected in the following way: determining the rotation matrix of the image collection device between the first position where the previous frame image is collected and the second position where the current frame image is collected according to a first IMU parameter value of the image collection device when collecting the previous frame image, and a second IMU parameter value of the image collection device when collecting the current frame image.

In an embodiment, the posture offset information includes a translation vector. The determining module 600 is specifically configured to determine at least one feature region from the previous frame image based on a GFTT feature extraction algorithm, in which a difference between a gray value of an edge pixel point of the feature region and a gray value of an adjacent pixel point except the one in the feature region is greater than a preset threshold; determine second position information of each feature region in the current frame image according to first position information of the feature region in the previous frame image and an optical flow tracking algorithm; and optimize the first position information of the at least one feature region in the previous frame image and the second position information of the at least one feature region in the current frame image based on a PNP algorithm to obtain the translation vector of the image collection device between the first position where the previous frame image is collected and the second position where the current frame image is collected.

Regarding the apparatus in the above embodiments, specific manners of the individual module for performing the operations have been described in detail in the embodiments related to the methods, which will not be elaborated herein.

FIG. 7 is a block diagram showing an electronic device 700 according to an exemplary embodiment. The electronic device may at least include at least one processor 710 and at least one memory 720.

The memory 720 stores program codes. The memory 720 may include a stored program area and a stored data area, in which, the stored program area can store an operating system, and programs required for running instant messaging functions, and the stored data area can store various instant messaging information and a set of operating instructions.

The memory 720 may be a volatile memory, such as a random-access memory (RAM); the memory 720 may also be a non-volatile memory, such as a read-only memory, a flash memory, a hard disk drive (HDD) or a solid-state drive (SSD), or the memory 720 is any other medium capable of carrying or storing desired program code in the form of instructions or data structures and capable of being accessed by a computer, but is not limited thereto. The memory 720 may be a combination of the above-described memories.

The processor 710 may include one or more central processing units (CPU) or be a digital processing unit or the like. In a case where the processor 710 invokes the program codes stored in the memory 720, operations in the image processing methods of various exemplary embodiments of the present disclosure described above are executed.

In an exemplary embodiment, a non-volatile computer storage medium having stored therein instructions, such as a memory 720, is provided. The instructions can be executable by the processor 710 of the electronic device 700 to complete the above-mentioned method. In some embodiments, the storage medium may be a non-transitory computer-readable storage medium, for example, the non-transitory computer-readable storage medium may be a ROM, a random access memory (RAM), a CD-ROM, a magnetic tape, a floppy disk, and an optical data storage device, etc.

The embodiments of the present disclosure also provide a computer program product. In response to the computer program product being operated on an electronic device, the electronic device implements any of the above image processing methods or any method that is related to the above image processing method.

Other embodiments of the present disclosure will be apparent to those skilled in the art from consideration of the specification and practice of the present disclosure disclosed herein. The present disclosure is intended to cover any variations, uses, or adaptive modifications of the present disclosure following the general principles thereof and including common general knowledge or conventional techniques in the art not disclosed by this disclosure. It is intended that the specification and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. An image processing method, comprising:
acquiring a current frame image from a collected video;
obtaining an initial depth image corresponding to the current frame image according to a convolutional neural network;
determining a predicted depth image corresponding to the current frame image according to posture offset information corresponding to the current frame image and a previous frame image of the current frame image, wherein the posture offset information indicates a posture offset of an image collection device between a first position where the previous frame image is collected and a second position where the current frame image is collected;
fusing an initial depth value in the initial depth image and a predicted depth value in the predicted depth image of a pixel point at a same position in the initial depth image and the predicted depth image to obtain a target depth value corresponding to the pixel point; and
generating a depth image corresponding to the current frame image according to the target depth value corresponding to the pixel point in the current frame image.

2. The method of claim 1, wherein said determining the predicted depth image corresponding to the current frame image according to the posture offset information and the previous frame image of the current frame image comprises:
converting a pixel coordinate of any pixel point in the previous frame image into a first spatial coordinate according to an internal parameter of the image collection device;
converting the first spatial coordinate into a second spatial coordinate according to the posture offset information;
determining the pixel point as a propagating pixel point in the current frame image in response to a pixel coordinate converted from the second spatial coordinate being within a preset range, and determining a predicted depth value of the propagating pixel point according to the second spatial coordinate;
determining a predicted depth value of a newly added pixel point except the propagating pixel point in the current frame image as a preset depth value; and
determining the predicted depth image corresponding to the current frame image according to the predicted depth value of the propagating pixel point and the predicted depth value of the newly added pixel point.

3. The method of claim 2, wherein said determining the predicted depth image corresponding to the current frame image according to the predicted depth value of the propagating pixel point and the predicted depth value of the newly added pixel point comprises:
determining a position of the propagating pixel point in the current frame image according to the pixel coordinate converted from the second spatial coordinate, and taking another position in the current frame image except the position of the propagating pixel point as a position of the newly added pixel point in the current frame image; and
generating the predicted depth image corresponding to the current frame image according to the position of the propagating pixel point in the current frame image, the predicted depth value of the propagating pixel point, the position of the newly added pixel point in the current image, and the predicted depth value of the newly added pixel point.

4. The method of claim 2, wherein said fusing the initial depth value in the initial depth image and the predicted depth value in the predicted depth image of the pixel point at the same position in the initial depth image and the predicted depth image to obtain the target depth value corresponding to the pixel point comprises:
determining the target depth value corresponding to the pixel point according to the initial depth value and the predicted depth value of the pixel point at the same position, a first weight value corresponding to the initial depth value, and a second weight value corresponding to the predicted depth value.

5. The method of claim 4, further comprising:
determining an initial propagation uncertainty parameter corresponding to the pixel point according to a difference between the initial depth value and the predicted depth value, and determining a regulatory factor for adjusting the initial propagation uncertainty parameter according to the difference between the initial depth value and the predicted depth value; and
adjusting the initial propagation uncertainty parameter according to the regulatory factor and a ratio of the initial depth value to the predicted depth value, and determining the first weight value corresponding to the initial depth value.

6. The method of claim 4, further comprising:
in response to the pixel point being the propagating pixel point, determining a second weight value corresponding to the predicted depth value of the propagating pixel point as a propagation uncertainty parameter of the pixel point in the previous frame image corresponding to the propagating pixel point, wherein the propagation uncertainty parameter represents a degree of change between a depth value of a propagating pixel point and a depth value of a corresponding pixel point in a previous frame image; or
in response to the pixel point being the newly added pixel point, determining a second weight value corresponding to the predicted depth value of the newly added pixel point as a first preset value.

7. The method of claim 6, further comprising:
determining the propagation uncertainty parameter of the propagating pixel point in each frame image according to the first weight value corresponding to the initial depth value of the propagating pixel point and the second weight value corresponding to the predicted depth value of the propagating pixel point; or
determining the propagation uncertainty parameter of the newly added pixel point in each frame image as a second preset value.

8. The method of claim 7, wherein said determining the propagation uncertainty parameter of the propagating pixel point according to the first weight value corresponding to the initial depth value of the propagating pixel point and the second weight value corresponding to the predicted depth value of the propagating pixel point comprises:
determining the propagation uncertainty parameter of the propagating pixel point as a ratio of a product of the first weight value corresponding to the initial depth value of the propagating pixel point and the second weight value corresponding to the predicted depth value of the propagating pixel point to a sum of the first weight value corresponding to the initial depth value of the propagating pixel point and the second weight value corresponding to the predicted depth value of the propagating pixel point.

9. The method of claim 1, wherein the posture offset information comprises a rotation matrix, and the method further comprises:
determining the rotation matrix of the image collection device between the first position where the previous frame image is collected and the second position where the current frame image is collected according to a first IMU parameter value of the image collection device when collecting the previous frame image, and a second IMU parameter value of the image collection device when collecting the current frame image.

10. The method of claim 1, wherein the posture offset information comprises a translation vector, and the method further comprises:
determining at least one feature region from the previous frame image based on a GFTT feature extraction algorithm, wherein a difference between a gray value of an edge pixel point of the feature region and a gray value of an adjacent pixel point except the one in the feature region is greater than a preset threshold;
determining second position information of each feature region in the current frame image according to first position information of the feature region in the previous frame image and an optical flow tracking algorithm; and
optimizing the first position information of the at least one feature region in the previous frame image and the second position information of the at least one feature region in the current frame image based on a PNP algorithm to obtain the translation vector of the image collection device between the first position where the previous frame image is collected and the second position where the current frame image is collected.

11. An electronic device, comprising:
a processor; and
a memory for storing executable instructions;
wherein the processor is configured to execute the executable instructions to implement steps, comprising:
acquiring a current frame image from a collected video;
obtaining an initial depth image corresponding to the current frame image according to a convolutional neural network;
determining a predicted depth image corresponding to the current frame image according to posture offset information corresponding to the current frame image and a previous frame image of the current frame image, wherein the posture offset information indicates a posture offset of an image collection device between a first position where the previous frame image is collected and a second position where the current frame image is collected;
fusing an initial depth value in the initial depth image and a predicted depth value in the predicted depth image of a pixel point at a same position in the initial depth image and the predicted depth image to obtain a target depth value corresponding to the pixel point; and
generating a depth image corresponding to the current frame image according to the target depth value corresponding to the pixel point in the current frame image.

12. The electronic device of claim 11, wherein the processor is configured to:
convert a pixel coordinate of any pixel point in the previous frame image into a first spatial coordinate according to an internal parameter of the image collection device;
convert the first spatial coordinate into a second spatial coordinate according to the posture offset information;
determine the pixel point as a propagating pixel point in the current frame image in response to a pixel coordinate converted from the second spatial coordinate being within a preset range, and determine a predicted depth value of the propagating pixel point according to the second spatial coordinate;
determine a predicted depth value of a newly added pixel point except the propagating pixel point in the current frame image as a preset depth value; and
determine the predicted depth image corresponding to the current frame image according to the predicted depth value of the propagating pixel point and the predicted depth value of the newly added pixel point.

13. The electronic device of claim 12, wherein the processor is configured to:
determine a position of the propagating pixel point in the current frame image according to the pixel coordinate converted from the second spatial coordinate, and take another position in the current frame image except the position of the propagating pixel point as a position of the newly added pixel point in the current frame image; and
generate the predicted depth image corresponding to the current frame image according to the position of the propagating pixel point in the current frame image, the predicted depth value of the propagating pixel point, the position of the newly added pixel point in the current image, and the predicted depth value of the newly added pixel point.

14. The electronic device of claim 12, wherein the processor is configured to:
determine the target depth value corresponding to the pixel point according to the initial depth value and the predicted depth value of the pixel point at the same position, a first weight value corresponding to the initial depth value, and a second weight value corresponding to the predicted depth value.

15. The electronic device of claim 14, wherein the processor is configured to:
determine an initial propagation uncertainty parameter corresponding to the pixel point according to a difference between the initial depth value and the predicted depth value, and determine a regulatory factor for adjusting the initial propagation uncertainty parameter according to the difference between the initial depth value and the predicted depth value; and
adjust the initial propagation uncertainty parameter according to the regulatory factor and a ratio of the initial depth value to the predicted depth value, and determine the first weight value corresponding to the initial depth value.

16. The electronic device of claim 14, wherein the processor is configured to:
in response to the pixel point being the propagating pixel point, determine a second weight value corresponding to the predicted depth value of the propagating pixel point as a propagation uncertainty parameter of the pixel point in the previous frame image corresponding to the propagating pixel point, wherein the propagation uncertainty parameter represents a degree of change between a depth value of a propagating pixel point and a depth value of a corresponding pixel point in a previous frame image; or
in response to the pixel point being the newly added pixel point, determine a second weight value corresponding to the predicted depth value of the newly added pixel point as a first preset value.

17. The electronic device of claim 16, wherein the processor is configured to:
determine the propagation uncertainty parameter of the propagating pixel point in each frame image according to the first weight value corresponding to the initial depth value of the propagating pixel point and the second weight value corresponding to the predicted depth value of the propagating pixel point; or
determine the propagation uncertainty parameter of the newly added pixel point in each frame image as a second preset value.

18. The electronic device of claim 17, wherein the processor is configured to:
determine the propagation uncertainty parameter of the propagating pixel point as a ratio of a product of the first weight value corresponding to the initial depth value of the propagating pixel point and the second weight value corresponding to the predicted depth value of the propagating pixel point to a sum of the first weight value corresponding to the initial depth value of the propagating pixel point and the second weight value corresponding to the predicted depth value of the propagating pixel point.

19. The electronic device of claim 11, wherein one of the following:
wherein the posture offset information comprises a rotation matrix; and
the processor being further configured to determine the rotation matrix of the image collection device between the first position where the previous frame image is collected and the second position where the current frame image is collected according to a first IMU parameter value of the image collection device when collecting the previous frame image, and a second IMU parameter value of the image collection device when collecting the current frame image;
or
wherein the posture offset information comprises a translation vector;
the processor being further configured to:
determine at least one feature region from the previous frame image based on a GFTT feature extraction algorithm, wherein a difference between a gray value of an edge pixel point of the feature region and a gray value of an adjacent pixel point except the one in the feature region is greater than a preset threshold;
determine second position information of each feature region in the current frame image according to first position information of the feature region in the previous frame image and an optical flow tracking algorithm; and
optimize the first position information of the at least one feature region in the previous frame image and the second position information of the at least one feature region in the current frame image based on a PNP algorithm to obtain the translation vector of the image collection device between the first position where the previous frame image is collected and the second position where the current frame image is collected.

20. A non-transitory computer-readable storage medium having stored therein executable instructions that, in response to the executable instructions being executed by a processor, cause an image processing method to be implemented, the method comprising:
acquiring a current frame image from a collected video;
obtaining an initial depth image corresponding to the current frame image according to a convolutional neural network;
determining a predicted depth image corresponding to the current frame image according to posture offset information corresponding to the current frame image and a previous frame image of the current frame image, wherein the posture offset information indicates a posture offset of an image collection device between a first position where the previous frame image is collected and a second position where the current frame image is collected;
fusing an initial depth value in the initial depth image and a predicted depth value in the predicted depth image of a pixel point at a same position in the initial depth image and the predicted depth image to obtain a target depth value corresponding to the pixel point; and
generating a depth image corresponding to the current frame image according to the target depth value corresponding to the pixel point in the current frame image.
